(19) United States
(12) Patent Application Publication
(10) Pub. No.: US 2004/0194638 A1
(43) Pub. Date: Oct. 7, 2004

(54) Filled waffle product and method of making

(76) Inventor: Philip B. Davis, Shaker Hts., OH (US)

Correspondence Address: Carmen R. Adams, #2212, 5459 Ballantyne Commons Parkway, Charlotte, NC, 28277, US

(21) Appl. No.: 10/404,734

(22) Filed: Apr. 1, 2003

(51) Int. Cl. A47J 9/00

(52) U.S. Cl. 99/372

(57) ABSTRACT

A filled waffle product and method of preparing same is disclosed. The filled waffle product comprises an outer casing and a filling material. The outer casing is essentially comprised of flour, eggs, and a liquid. The filling material is comprised of cooked chicken pieces or other edible materials. The filling materials may be used individually or in combination one with the other. The filled waffle product is prepared by adding an amount of raw batter and filling material to a preheated baking mold, closing the baking mold, and heating the batter in the baking mold to at least partially cook the batter and substantially encapsulate the filling material in the batter. The filled waffle product is then removed from the baking mold for immediate consumption, or frozen and packaged for storage and later consumption.

### BACKGROUND OF THE INVENTION

Typically, when served in sit-down restaurants, waffles are prepared separately and served with other food items such as fried chicken, bacon, eggs, and fruit. The fried chicken and waffle combination has become more popular, resulting in the increase in the number of sit down restaurants that serve chicken and waffles as their main fare.

Generally, waffles are prepared by pouring a batter consisting essentially of flour, eggs, milk, shortening, and sugar into a heated baking mold or waffle iron. The mold typically has a bottom and top half that are connected by a hinge that allows one half to close over the other. When the halves are closed together, the batter is compressed and the opposite faces of the batter conform to the respective surfaces of the bottom and top halves of the mold. The heated halves of the baking mold remain closed until the batter is cooked to form a solid waffle. The other food items are prepared separately in the traditional manner of preparation and served alongside or on top of the cooked waffle.

With the increase in popularity of the fried chicken and waffle combination, there is a need for a quick and neat method of preparing and serving the chicken and waffle combination so that it can be conveniently and easily served at fast food restaurants and concession stands in facilities such as sports stadiums and arenas, and amusement parks. In most instances, these facilities require that food products be prepared in a manner that allows the consumer to eat using one hand or that accommodates serving the food product without a plate or utensils.

Thus, previous methods of preparing and serving the chicken and waffle combination suffer from several drawbacks. First, the time required to separately prepare each food item is considerable. Second, previous methods require utensils and a serving plate for ease of consumption. Furthermore, because the items are prepared and served separately, it is inconvenient and essentially impossible to consume them while standing or using one hand.

### SUMMARY OF THE INVENTION

The present invention provides a filled waffle food product comprising a filling material and a batter, wherein the batter is cooked onto and substantially encapsulates the filling material. In one embodiment of the invention the batter is comprised essentially of flour, eggs, and a liquid. In a preferred embodiment of the present invention, the liquid is a milk product. The batter may also include a liquid or soft solid fat product, sugar, and spices. In one embodiment of the present invention, the filling material is cooked chicken pieces. However other edible filling materials may be used.

The present invention further provides a method of preparing a filled waffle food product. In one embodiment of the present invention, a batter consisting essentially of flour, a liquid or soft solid fat product, eggs and a liquid is prepared. The batter is poured into a baking mold consisting of top and bottom halves hingedly connected so that the top and bottom halves are aligned when closed together. The baking mold is heated to a temperature sufficient to cook the batter. The batter is poured into the baking mold and a filling material is placed in the batter. In one embodiment of the present invention, the filling material comprises cooked chicken pieces. The baking mold is then closed and the batter is cooked and substantially encapsulates the filling material. The baking mold is then opened and the filled waffle food product is removed from the baking mold. In another embodiment of the present invention, the cooked filled waffle product is frozen and sealed in microwavable package to preserve freshness during storage.

These and other benefits and advantages of the present invention will no doubt become obvious to those of ordinary skill in the art after reading the following detailed description of the preferred embodiments that are illustrated in the various drawing figures.

### BRIEF DESCRIPTION OF THE DRAWINGS

FIG. 1 is a perspective view of the filled waffle product of the present invention.

FIG. 2 is a cross-sectional view of the filled waffle product of the present invention.

FIG. 3 is a perspective view of the mold used to prepare the filled waffle product of the present invention.

FIG. 4 is a perspective view of the mold used to prepare the filled waffle product of the present invention partially filled with uncooked batter and filling material.

### DETAILED DESCRIPTION OF THE INVENTION

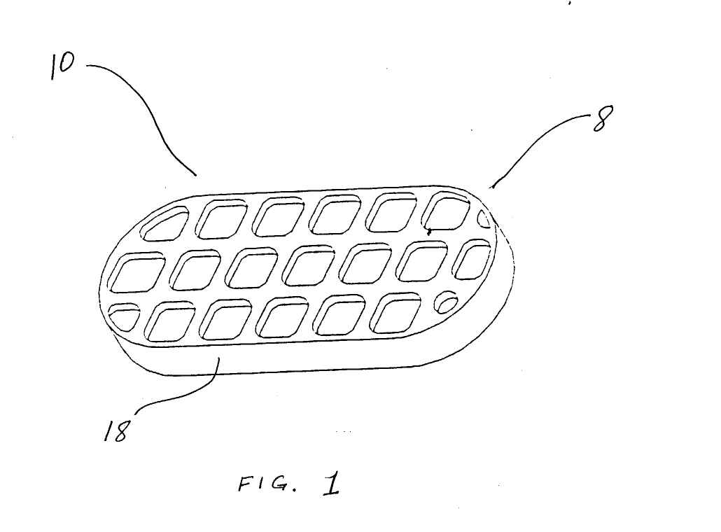

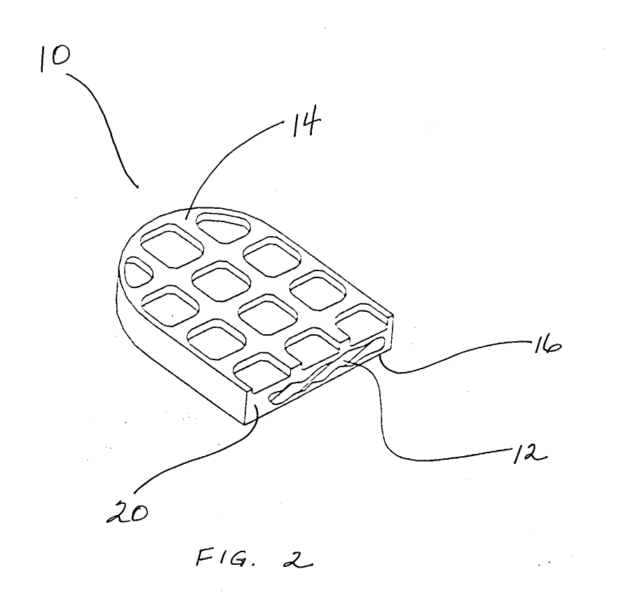

Referring to FIGS. 1 and 2, one embodiment of the filled waffle product is shown generally at 10. The filled waffle product 10 is comprised of an outer casing 8 and a filling material 12. The outer casing 8 is essentially comprised of a cooked batter material 20. The cooked batter material 20 substantially encapsulates the filling material 12. The outer casing 8 is comprised of a top 14, a bottom 16, and a peripheral edge 18. FIGS. 1 and 2 illustrate an oval shaped filled waffle product 10. However, the filled waffle product 10 can take on any other shape or configuration formed by a baking mold or waffle iron. The outer casing 8 may be patterned or smooth depending in the surface characteristics of the baking mold or waffle iron used to prepare the filled waffle product 10. Likewise, the shape and height of the peripheral edge 18 can vary based on the shape and configuration of the waffle iron or baking mold used to prepare the filled waffle product 10.

FIG. 2 is a cross-sectional view of one embodiment of the filled waffle product 10 of the present invention. The filling material 12 is substantially encapsulated by the cooked batter material 20. The cooked batter material 20 is comprised essentially of flour, eggs, and a liquid. Preferably, the liquid used to prepare the filled waffle product 10 is a milk product. In a preferred embodiment of the filled waffle product 10, the cooked batter material 20 may also include a liquid or soft solid fat product, sugar, and spices. In a preferred embodiment of the present invention, the filling material 12 is cooked chicken pieces. However other edible filling materials may be used individually or in combination with one another.

In one embodiment of the present invention, the filled waffle product 10 is partially or completely cooked and then frozen and sealed in microwavable packages to preserve freshness during storage. The filled waffle product 10 may then be stored for later consumption.

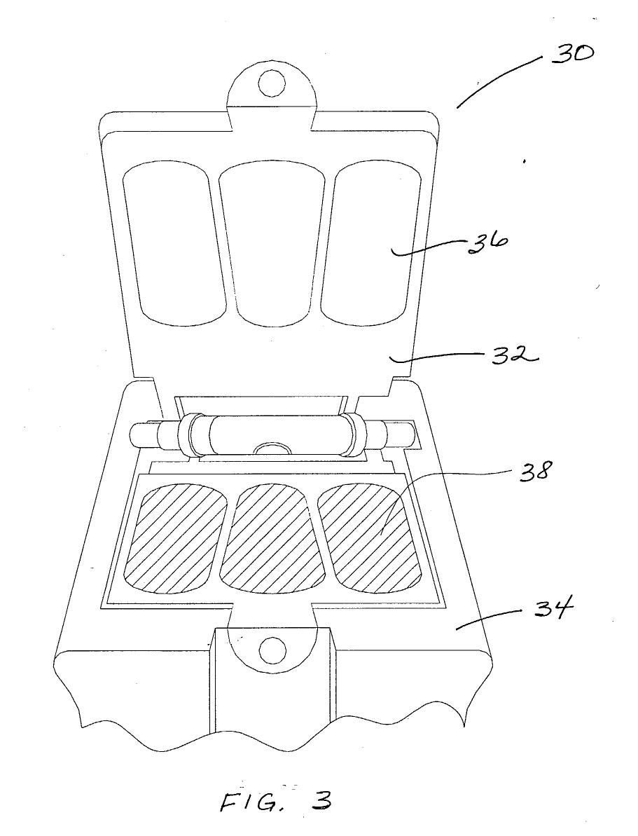

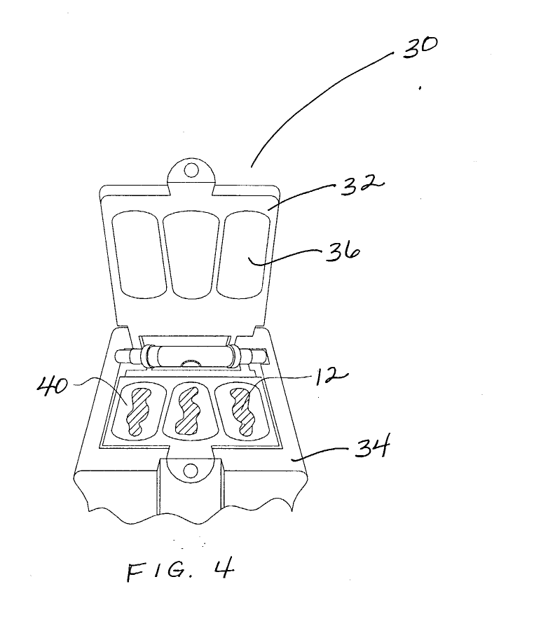

Referring to FIGS. 3 and 4, one embodiment of a waffle iron or baking mold used to prepare the filled waffle product 10 of the present invention is shown generally at 30. The baking mold 30 includes a top plate 32 and a bottom plate 34. The top plate 32 and bottom plate 34 are hingedly connected so that the top plate 32 and bottom plate 34 are essentially aligned when the baking mold 30 is closed. The top plate 32 includes one or a plurality of cavities 36. The bottom plate 34 includes one or a plurality of cavities 38. In a preferred embodiment of the method of the present invention, the cavities 36 in the top plate 32 and the cavities 38 in the bottom plate 34 essentially identical in shape and are aligned so that the cavities 36 in the top plate 32 and the cavities 38 in the bottom plate 34 are essentially mirrored when the baking mold 30 is in a closed position.

Referring to FIG. 4, raw batter material 40 and filling material 12 are added to the preheated baking mold 30. The baking mold 30 is preheated to a temperature sufficient to cook the raw batter material 40. In a preferred embodiment of the method of the present invention, the baking mold 30 is heated to about 350 degrees Fahrenheit. The baking mold 30 is closed to heat the raw batter material 40 and filling material 12 until the raw batter material 40 is cooked and substantially encapsulates the filling material 12. Preferably, the baking mold is closed for between about 3 and about 5 minutes to fully cook the raw batter material 40. The baking mold 30 is opened and the partially of fully cooked filled waffle product 10 is removed from the baking mold 30. In one embodiment of the method of the present invention, a spray, semi-solid, or liquid lubricant is applied to the top plate 32 and bottom plate 34 to reduce or essentially eliminate sticking of the uncooked batter material 40 and filling material 12 to the top plate 32 and bottom plate 34 during cooking.

The fully cooked filled waffle product 10 can be consumed immediately after removal from the baking mold 30 or frozen and packaged for later consumption. In another embosiment of the method of the present invention, the filled waffle product 10 is only partially cooked and then frozen and packaged for later consumption. Preferable, the frozen filled waffle product 10 is packaged in microwavable material. The filled waffle product 10 can then be reheated in a microwave oven without removing the packaging material. The filled waffle product 10 can also be removed from the packaging material and reheated or cooked completely in a toaster, oven, microwave oven, or other apparatus used for heating and cooking.

It should be understood that the above described embodiments merely illustrate the invention in selected form. It should be apparent to to those persons skilled in the art that such embodiments may be modified in the arrangement and detail without departing from the spirit of the invention. I claim as my invention all such modifications as lie within the true spirit and scope of the invention as defined by the following claims.

What is claimed is:

1. A filled waffle food product comprising a filling material and a batter, wherein the batter is cooked onto and substantially encapsulates the filling material.

2. The filled waffle food product of claim 1 wherein the batter is comprised essentially of flour, eggs, and a liquid.

3. The filled waffle food product of claim 2 wherein the liquid is a milk product.

4. The filled waffle food product of claim 2 further comprising a liquid or soft solid fat product, sugar, and spices.

5. The filled waffle food product of claim 1 wherein the filling material is cooked chicken pieces.

6. A method of preparing a filled waffle food product comprising:
preparing a batter consisting essentially of flour, a liquid or soft solid fat product, eggs and a liquid;
providing a baking mold, the baking mold consisting of top and bottom halves hingedly connected so that the top and bottom halves are aligned when closed together;
beating the baking mold to a temperature sufficient to cook the batter;
adding an amount of the batter and filling material to the baking mold;
closing the baking mold;
heating the batter in the baking mold to at least partially cook the batter and substantially encapsulate filling material in the batter; and
opening the baking mold and removing the filled waffle food product from the baking mold.

7. The method of claim 6 wherein the filling material is cooked chicken pieces

8. The method of claim 6 further comprising:
freezing the filled waffle food product;
packaging the frozen filled waffle food product in a sealed package to preserve freshness during storage.
